(19) United States
(12) Patent Application Publication
(10) Pub. No.: US 2003/0022133 A1
(43) Pub. Date: Jan. 30, 2003

(54) Open upper denture

(76) Inventor: Jin H. Kim, Piedmont, CA (US)

Correspondence Address: Harris Zimmerman, Law Offices of Harris Zimmerman, 1330 Broadway, Suite 710, Oakland, CA, 94612-2506, US

(21) Appl. No.: 09/917,352

(22) Filed: Jul. 30, 2001

(51) Int. Cl. A61C 13/00

(52) U.S. Cl. 433/167; 433/190

(57) ABSTRACT

An upper denture has an artificial teeth support base with side regions and a front region shaped for fitting onto a person's upper gums. The support base has an open area situated between the side regions and behind the front region and which exposes a portion of the roof of the wearer's mouth at that location. An arched center region of the support base extends between the side regions behind the open area and is shaped to fit against the roof of the mouth. The open configuration makes the denture more comfortable and provides a more natural environment in the mouth. For example, the tongue and foods and beverages may make direct contact with the top of the mouth. The support base may be articulated in a manner which enables adjustment of the fit of the denture after fabrication.

### BACKGROUND OF THE INVENTION

This invention relates to dentures which provide artificial teeth within the human oral cavity and more particularly to maxillary dentures or upper plates for use in the upper portion of the mouth.

Conventional upper dentures which replace a person's upper teeth have a configuration that can be discomforting to the wearer in several ways. The conventional upper plate covers the arched roof of the mouth between the upper gums or alveolar ridges. Consequently, the person's tongue cannot directly contact the roof of the mouth. This is often unpleasant to the wearer of the denture and can adversely affect the person's capacity for tasting foods and beverages.

Dentures are fabricated to conform with the individual contours of the portions of the persons mouth that are contacted by the denture. Adjustment of the fit of the conventional denture after fabrication has been at best a complicated process. Such adjustment can be desirable to correct for manufacturing irregularities or because of changes in the configuration of the person's mouth that may occur over a period of time.

The present invention is directed to overcoming one or more of the problems discussed above.

### BRIEF SUMMARY OF THE INVENTION

In one aspect the present invention provides an upper denture having a support base with artificial teeth supported therein, the support base having side regions and a front region shaped for fitting onto the upper gums of a wearer's mouth. The support base has an open area situated between the side regions and which exposes a portion of the roof of the wearer's mouth at that location.

In another aspect the invention provides an upper denture having a support base with artificial teeth supported therein, the support base having side regions and a front region shaped for fitting onto the upper gums of a wearer's mouth and having an upwardly arched back region which extends between the side regions at the back of the denture. The support base has an open area situated between the side regions and between the front region and back region and which exposes a portion of the roof of the wearer's mouth at that location.

In still another aspect of the invention, the support base of the denture has joints positioned to enable pivoting of side regions of the support base relative to the front region thereof and the back region has separate right and left side section which are movable relative to each other to accommodate to pivoting of the side regions.

The invention provides an upper denture which is more comfortable to the wearer and which provides a more natural environment within the mouth. The open area at the center of the denture enables direct contact of the person's tongue with the roof of the mouth and foods and beverages may also contact the roof of the mouth. The person is less aware of the presence of the denture and tasting of foods and beverages is enhanced. The denture may have a jointed construction which enables adjustment of the fit of the denture to correct for fabrication irregularities or to accommodate to changes in the contours of the mouth which may occur over a period of time.

The invention, together with further objects and advantages thereof, may be further understood by reference to the following detailed description of the invention and by reference to the accompanying drawings.

### BRIEF DESCRIPTION OF THE DRAWINGS

FIG. 1 is a view of the underside of an upper denture in accordance with a first embodiment of the invention.

FIG. 2 is a back end view of the upper denture of FIG. 1.

FIG. 3 is a view of the underside of another upper denture embodying the invention which second embodiment includes structural features that enable adjustment of the fit of the denture after fabrication of the denture.

FIG. 4 is an enlarged section view of a portion of the denture of FIG. 3 taken along line 4-4 thereof.

FIG. 5 is a section view of the portion of the denture of FIG. 3 that is enclosed by dashed line 5 thereof.

FIG. 6 is a side view of a portion of the denture of FIGS. 3 to 5 taken along line 6-6 of FIG. 5.

### DETAILED DESCRIPTION OF THE INVENTION

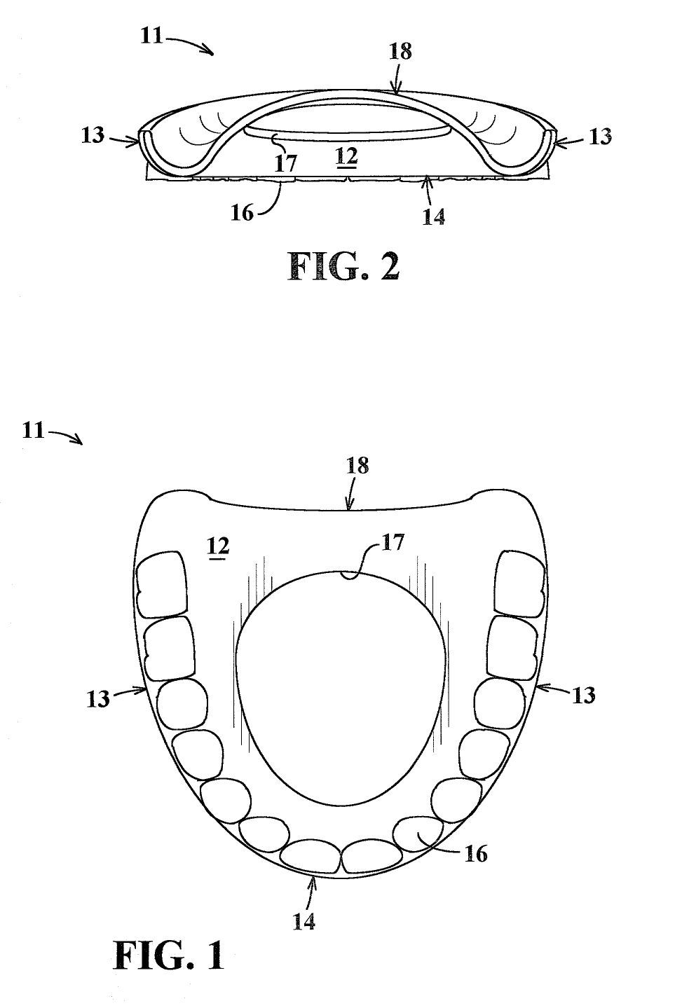

Referring jointly to FIGS. 1 and 2 of the drawings, _an upper denture 11 in accordance with this example of the invention has a support base 12 shaped to fit into the upper region of the wearer's oral cavity. More particularly, support base 11 has curving side regions 13 and a front region 14 which are of generally trough shaped configuration in order to fit onto the upper gums or alveolar ridges of the wearer. Artificial teeth 16 conforming to natural teeth extend from the underside of support base 12.

Except as hereinafter described, the support base 12 including artificial teeth 16 may be fabricated by the molding process customarily used for conforming a denture with a particular person's mouth and may be formed of the customary plastic materials.

Denture 11 differs from prior upper dentures by having an open area 17 situated between the side regions 13 and behind the front region 14 of support base 12. This increases wearer comfort by enabling direct contact of the wearer's tongue and direct contact of foods and beverages with the roof of the mouth.

In the preferred form of the invention retention of the denture 11 is enhanced and the denture is strengthened by providing the support base 12 with a back region 18 which extends between the side regions 13 behind the open area 17. The back region 18 is upwardly arched and shaped to conform with the roof of the wearer's mouth.

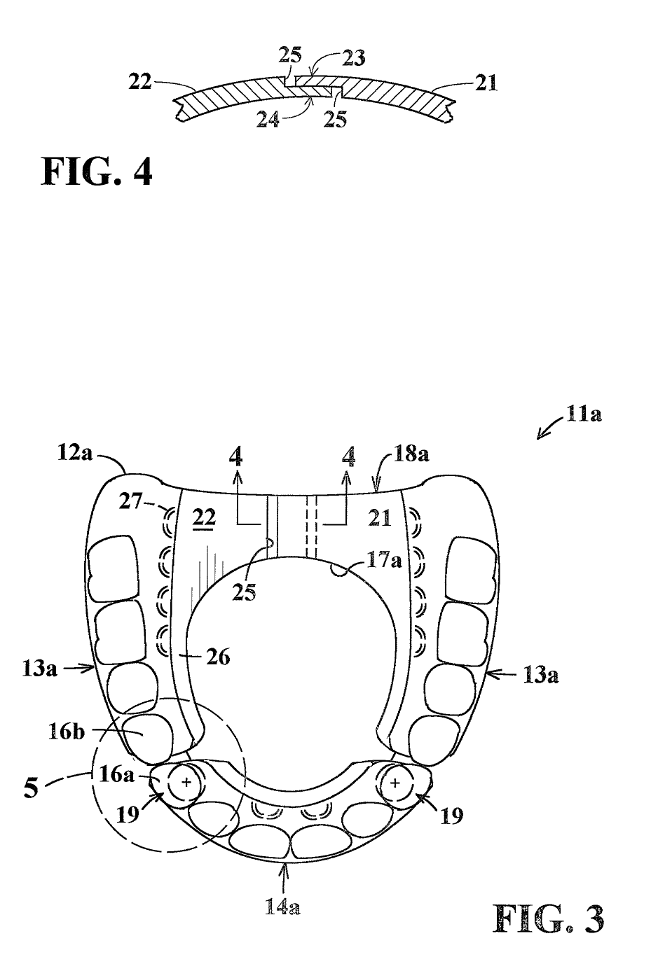

The open configuration of the denture can facilitate adjustment of the fit of the denture to a particular person's mouth. Such adjustment can be helpful to correct for non-conformities which arise during the fabrication process or to accommodate to changes in the contours of a person's mouth that occur over a period of time. FIG. 3 depicts another embodiment of the invention in which the denture 11a has a jointed construction enabling such adjustment.

Referring to FIGS. 3 and 4, the side regions 13a and the front region 14a of denture 11a are separable segments of the support base 12a. A pair of pivot joints 19 attach the ends of front region 14a to the adjacent ends of side regions 13a. Back region 18a of the support base 12a has separate right and left side sections 21 and 22 with overlapping edges 23 and 24 at the center of the back region. This enables changing of the angling of the side sections 21 and 22 relative to the front region 14a and relative to each other. Overlapping edges 23 and 24 enable extension and contraction of the back region 18a as a whole and turning of one section relative to the other to accommodate to the pivoting of the side regions. Thus the jointed construction enables a substantial amount of self adjustment of the denture 11a as it is placed in the mouth to improve the fit of the denture 11a.

The overlapping edges 23 and 24 of the support base back region 18a are of reduced thickness relative to other portions of the back region and are proportioned to provide slots 25 which extend across back region 18a adjacent to each edge. If desired, the denture 11a can be rigidified following the above described fit adjustment by filling slots 25 with an adhesive. Subsequent readjustment of the fit of the denture 11a can be provided for by using a soluble adhesive. Alternately, if the overlapping edges 23 and 24 are formed of metal as in this example, the denture 11a may be rigidified by filling slots 25 with a non-toxic solder.

The denture 11a is strengthened and formation of the pivot joints 19 is facilitated by forming portions of the denture of high strength metal such as stainless steel. Metallic portions in this example include the right and left sections 21 and 22 of the support base back region 18a and the portions 26 of the side regions 13a which bound the open area 17a. Ribs 27 on sections 21 and 22 and on portions 26 extend into the adjacent plastic material to hold the metallic portions in place.

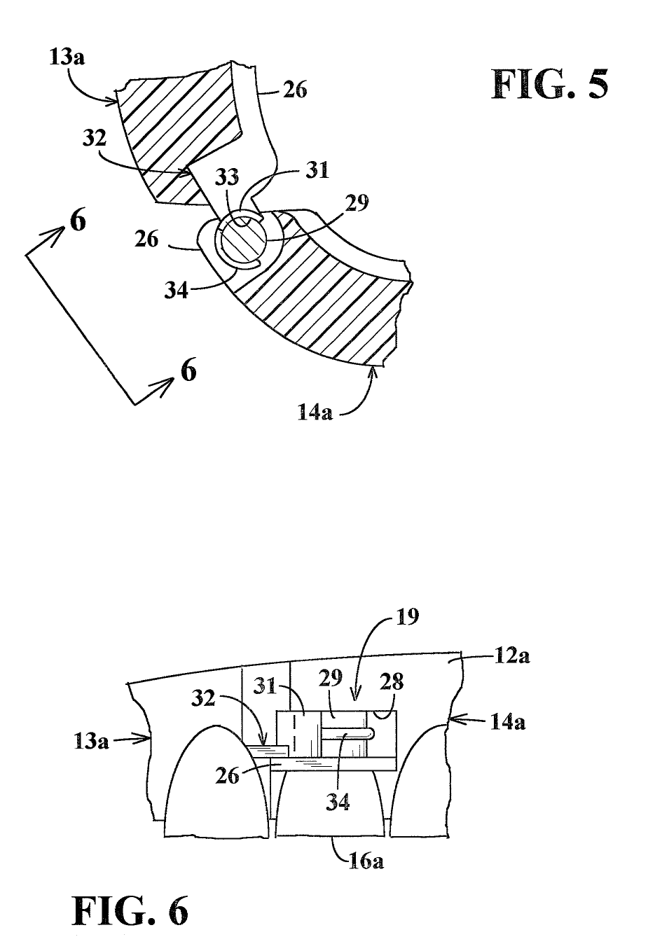

Segmentation of the support base 12a into side regions 13a and front region 14a in this example of the invention is at locations between the artificial canine teeth 16a and artificial front bicuspid teeth 16b. Referring jointly to FIGS. 5 and 6, notches 28 extend into the ends of the front region 14a of the support base 12a above the artificial canine teeth 16a. Pivot joints 19 are formed in part by vertically oriented cylinders 29 situated in the notches 28. The cylinders 29 are secured to the previously described metal portion 26 of the support base which is formed to extend under the cylinders. Positioning members 31 are secured to the support base side regions 13a and extend into the notches 28 of the front region 14a, 3b the positioning members being secured to extensions 32 of the metal portion 26 of the side members. The positioning members 31 have curved faces 33 which seat against cylinders 29. Semi-circular hooks 34 extend partially around cylinders 29, from positioning members 31, to clasp the front region 14a of support base 12a to the side regions 13a of the support base. Hooks 34 are formed of resilient metal to enable snap engagement of the hooks onto the cylinders 29.

While the invention has been described with reference to certain specific embodiments for purposes of example, many modifications and variations are possible and it is not intended to limit the invention except as defined by the following claims.

What is claimed is:

1. An upper denture having a support base with artificial teeth supported therein, said support base having side regions and a front region shaped for fitting onto the upper gums of a wearer's mouth, said support base having an open area situated between said side regions and which exposes a portion of the roof of the wearer's mouth at that location.

2. The upper denture of claim 1 wherein said open area extends substantially to said side regions and said front region of said support base.

3. The upper denture of claim 1 wherein said support base has an arched back region which extends between said side regions behind said open area and which is shaped for fitting against the roof of the wearer's mouth.

4. The upper denture of claim 3 wherein said side regions of said support base are joined to said front region of said support base by pivot joints which enable pivoting movement of said side regions relative to said front region and wherein said back region of said support base has right and left side sections which are moveable relative to each other to enable extension and contraction of said back region.

5. The upper denture of claim 4 wherein said front region of said support base has a cylindrical surface at each end thereof, and wherein said pivot joints include semi-circular hooks extending from said side regions of said support base and which clasp said cylindrical surfaces of said front region thereof.

6. The upper denture of claim 5 wherein said hooks are formed of resilient material enabling said hooks to be snapped onto said cylindrical surfaces of said front region of said support base.

7. The upper denture of claim 5 wherein said cylindrical surfaces are situated within notches at said ends of said front region of said support base.

8. The upper denture of claim 5 wherein said pivot joints include positioning members secured to said side regions of said support base and having curved surfaces positioned to seat against said cylindrical surfaces of said front region of said support base, and wherein said hooks extend from said positioning members.

9. The upper denture of claim 4 wherein said front region of said support base supports artificial incisor teeth and artificial canine teeth and said side regions of said support base support artificial bicuspid teeth and artificial molar teeth, said pivot joints being substantially at the location of said artificial canine teeth.

10. The upper denture of claim 5 wherein said arched back region of said support base and portions of said support base which bound said open area are formed of metal, other portions of said support base being formed of plastic, and wherein said hooks extend from the metal portions of said support base.

11. An upper denture having a support base with artificial teeth supported therein, said support base having side regions and a front region shaped for fitting onto the upper gums of a wearer's mouth and having an upwardly arched back region which extends between the side regions at the back of the denture, said support base having an open area situated between said side regions and between said front region and back region and which exposes a portion of the roof of the wearer's mouth at that location.

12. The denture of claim 11 wherein said support base has joints positioned to enable pivoting of said side regions relative to said front region and wherein said back region has separate right and left side sections which are movable relative to each other.
